(19) United States
(12) Patent Application Publication
(10) Pub. No.: US 2017/0371438 A1
(43) Pub. Date: Dec. 28, 2017

(54) METHOD AND SYSTEM FOR TRANSCRIBING MARKER LOCATIONS, INCLUDING ERASURES

(71) Applicant: LUIDIA GLOBAL CO., LTD, Seongnam-si, Gyeonggi-do (KR)

(72) Inventors: Bradley RICHTER, San Mateo, CA (US); Yao DING, San Jose, CA (US); Jootae "JT" KIM, Yongin-Si (KR); Jae-Jun LEE, Seoul (KR)

(73) Assignee: LUIDIA GLOBAL CO., LTD, Seongnam-si, Gyeonggi-do (KR)

(21) Appl. No.: 15/538,084

(22) PCT Filed: Dec. 21, 2015
(86) PCT No.: PCT/US2015/066965

§ 371 Date: Jun. 20, 2017

Related U.S. Application Data
(60) Provisional application No. 62/095,051, filed on Dec. 21, 2014.

(51) Int. Cl. G06F 3/0354; B43L 1/00; B43K 29/08; G06F 3/043; B43K 29/02

(52) U.S. Cl. CPC G06F 3/03545; G06F 3/043; B43K 29/02; B43K 29/08; B43L 1/00

(57) ABSTRACT

One embodiment is an apparatus for capturing marker stroke locations, including erasures. The marker includes a transmitter of acoustic pulses and an erasure cap detector that detects when a removable erasure cap is attached to the marker. A receiver includes two or more sensors to sense the acoustic pulses, the receiver operable to determine and track marker locations. When the removable erasure cap is attached to the marker, the marker locations are erasures, and when there is no erasure cap attached, the marker locations being tracked capture strokes. Another embodiment is a method of capturing marker stroke locations, including erasures, using the marker, the removable erasure cap for erasures, and the receiver.

### RELATED APPLICATIONS

The present invention claims benefit of priority to U.S. Provisional Patent Application No. 62/095,051 filed 21 Dec. 2014, the contents of which are incorporated herein by reference in each jurisdiction that permits incorporation of material by reference. In other jurisdictions that do not permit incorporation of material by reference, Applicant reserves the right to insert matter into the present specification from any material that is stated herein to be incorporates by reference, without such inserted matter being new matter.

### FIELD OF THE INVENTION

The present invention relates to systems for determining and transcribing digital marker locations using acoustical energy.

### BACKGROUND

Location determining and transcription systems (“location capture systems”) are known for locating and recording marker or electronic pen strokes on an ordinary surface, such as that of an ordinary whiteboard, on paper, on a projection screen, or on a flat-display surface. Luidia, Inc., the assignees of the present invention, has long been making a system called eBeam® that provides for recording strokes made on a surface such as an ordinary whiteboard using ordinary dry-erase markers inside an electronic marker sleeve. Such a marker sleeve converts an ordinary marker to an electronic marker. The marker sleeve and hence the electronic marker includes a transmitter for transmitting acoustic pulses and a transmitter for transmitting electromagnetic pulse signals, e.g., infrared (IR) pulses, and such a device, when used with a capture unit placed adjacent to an area, e.g., a whiteboard, is usable for locating and transcribing locations of the marker. Such an electronic marker is often referred to as a marker herein when the context is clear that such marker includes the transmitting element or elements. The capture unit typically includes two or more acoustic sensors for receiving the transmitted ultrasound and an infrared sensor to detect the IR pulses. The capture unit in some versions may include a processing engine with memory, and in some of these versions, processing and storage may be local. The capture unit includes an interface, e.g., a wireless connection or USB connection, to send information to a remote device. Examples of remote devices include, a so-called ““smart” phone that includes a processor, e.g., a phone operating under the iOS®, ANDROID®, or some other mobile device operating system, a tablet, a computer, personal digital assistant (PDA), a projector that includes a processor and memory, a TV or other flat-screen display device that includes a processor and memory, and so forth. Such a system, in combination with the computer, captures the marker strokes on or for remote device, including the color of the marker and any erasing.

### BRIEF DESCRIPTION OF THE DRAWINGS

FIG. 1 shows a simplified diagram of an example system that is connectable to a host device, and that includes aspects of the present invention.

FIG. 2 shows block diagram some elements of the system of FIG. 1, including an embodiment of the present invention.

FIG. 3 shows a simplified perspective view of the system that includes a marker (including sleeve), a receiver, and some erasure cap elements, including aspects of an embodiment of the present invention.

FIG. 4 shows a receiver, a marker sleeve (with marker), and a charging bracket with marker stroke determining capability, into which elements described herein may be included such that the combination operates as an embodiment of the invention.

FIG. 5 shows a vertical receiver arrangement with two whiteboards, one on the left and one on the right of the receiver, illustrating a feature of an embodiment of the invention.

FIG. 6 shows a perspective view of an example eraser that operates in an embodiment of the invention.

### DETAILED DESCRIPTION

### Overview

Described herein is an apparatus for capturing marker stroke locations, including erasures. The marker, e.g., a sleeve of the marker includes a transmitter of acoustic pulses and an erasure cap detector that detects when a removable erasure cap is attached to the marker, in which situation, the marker locations being tracked capture erasures. A receiver includes two or more sensors to sense the acoustic pulses, the receiver operable to determine and track marker locations. When there is no erasure cap attached, the marker locations being tracked capture strokes. Another embodiment is a method of capturing marker stroke locations, including erasures, using marker includes a transmitter of acoustic pulses and an erasure cap detector that detects when a removable erasure cap is attached to the marker. Also described herein is a method of capturing marker stroke locations, including erasures, using the marker that includes a transmitter of acoustic pulses and the erasure cap detector that detects when the removable erasure cap is attached to the marker.

Particular embodiments of the invention include an apparatus configured to capture strokes made by a marker, including capturing erasures when a removable erasure cap is attached to the marker. The apparatus includes a receiver configured to be placed on or close to an edge of a surface. The receiver includes at least two acoustic sensors located at pre-defined locations relative to each other and arranged to sense acoustic signals transmitted from the marker when the marker in an active area of the surface adjacent to the locations of the acoustic sensors. In some embodiments, the receiver includes a sensor of electromagnetic energy pulses transmitted from the marker.

The marker includes at least one transmitter to transmit acoustic signals detectable by the acoustic sensors. In some embodiments the marker further includes a transmitter that transmits electromagnetic energy, e.g., infrared (IR) pulses.

The receiver is arranged to determine and store locations and time information of the marker in the active area that includes a whiteboard surface, the active area adjacent to the acoustic sensors. The receiver further includes an interface to couple the receiver with a host device, the host device including a host processor and a memory. The receiver is operative, when coupled to the host device, to send determined locations and time information to the host device.

When the marker, e.g., a sleeve around the marker has a removable erasure cap thereon, the receiver alone, or in combination with the host device, is operative to accept an indication that the erasure cap is on the marker sleeve. The indication may be as a result of indication made by a user, or may be automatic by automatically detecting presence of the cap in the marker. Responsive to receiving the indication that the erasure cap in on the marker, e.g., on the sleeve, the marker-and-erasure-cap combination causes erasure of previously made strokes (annotations) erasure of previously made strokes at the determined locations of the marker-and-erasure-cap combination on the white board, e.g., those on the same “page.”

In some embodiments, the receiver alone, or in combination with the host device, is operative to accept or determine a plurality of indicators of page-flip, and to combine the plurality of indicators to automatically determine a page flip event. A page flip event may include complete erasure of the whiteboard.

In a first set of apparatus embodiments, the receiver is physically contained in a housing that includes two ultrasound sensors, sensing circuits therefor, an infrared detector, and in some embodiments, an accelerometer. In some apparatus embodiments, the receiver comprises a processing engine that includes a processor and a software memory, e.g., firmware memory, wherein the software or firmware in the memory includes instructions that when executed cause the determining and the storing of the locations and time information, the sending of the determined locations and time information to a host device with which the receiver is in communication.

Particular embodiments of the invention include a method of operating an apparatus that captures marker strokes, the method comprising:
receiving acoustic signals in at least two acoustic sensors housed in a receiver housing that is placed on or close to an edge of a surface, the sensors located at pre-defined locations relative to each other to sense acoustic signals transmitted from a marker e.g., a marker in a marker sleeve in an active area that comprises the surface adjacent and that is adjacent to the acoustic sensors, and in some versions, an additional sensor that is operative to detect electromagnetic signals, e.g., IR signals transmitted by the marker, the acoustic signals being transmitted from the marker by an acoustic transmitter included in the marker, and the electromagnetic signals being transmitted being transmitted by a transmitter of electromagnetic signals in the apparatus, e.g. in the marker; and
receiving signals from the marker indicative of whether or not an erasure cap is on the marker;
determining locations of the marker in the active area on the surface adjacent to the acoustic sensors and determining time information for the determined locations;
storing the determined locations and time information;
responsive to an indication that the erasure cap is present, sending the determined coordinates and timing information as erasure information of past events to a host device; and, in some versions,
accepting or determining a plurality of indicators of page-flip.

Particular embodiments include a non-transitory machine-readable medium coded with instructions, that when executed by a processing system, carry out any one of the above summarized methods.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

System Comprising a Marker (with Sleeve) and a Receiver

Described herein is a receiver that includes electronics for determining and capturing the locations of an electronic marker or pointer, to provide for a user the ability to create, save, store and retrieve hand written notes on both paper and digital media.

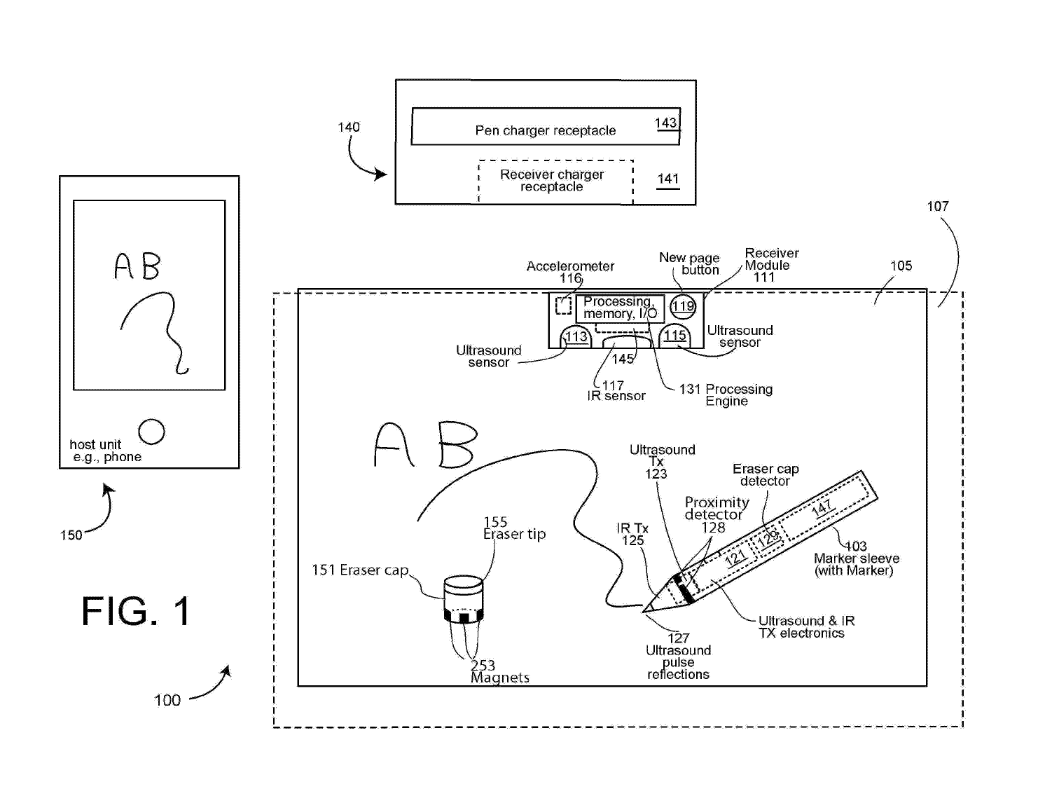

FIG. 1 shows a simplified diagram of an example system 100 that may be coupled to a host device 150—in this drawing, a smart phone 150, and that includes aspects of the present invention. The system 100 is for sketching or writing on a surface 105 which is assumed to be a whiteboard on which one can write with an electronic marker, or some surface on which one can electronically write with an electronic marker.

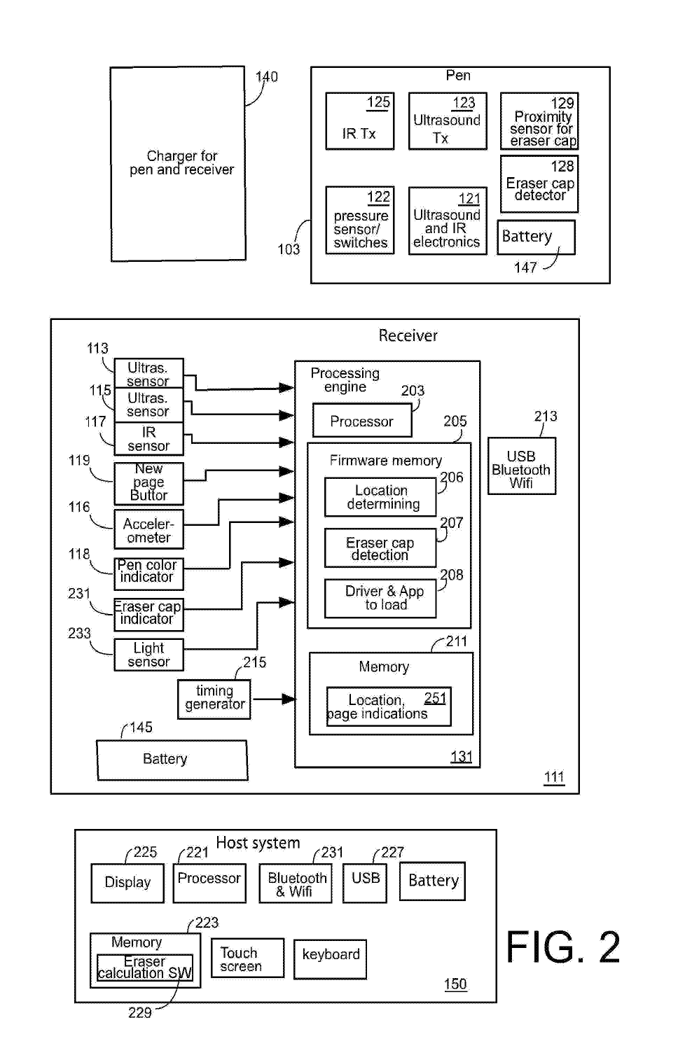

FIG. 2 shows a more detailed block diagram of the system shown on FIG. 1. The system 100 includes a receiver (receiver module 111) that is located at the periphery of the surface 105, e.g., on the edge of the surface. The receiver includes at least two acoustic sensors, e.g., ultrasound sensors with a known spatial relationship between each other. FIG. 1 shows a receiver 111 with two ultrasound sensors 113,115, and one infrared sensor 117. There is a known spatial relationship between the ultrasound sensors 113,115. Note that alternatively, a side edge may be selected, and the receiver placed so that the two ultrasound sensors are collinear on a vertical line. The receiver forms an active area 107 on a substantially planar surface adjacent to the location of the acoustic sensors. Active area 107 in one embodiment includes the surface 105. In one version, the system is calibrated or recalibrated such that the active area 107 is larger than the writing surface, e.g., as shown larger in three of the four edges of the surface 105. The system includes a processing engine 131 coupled to the sensors 113,115,117 of the receiver 111. The processing engine 131 is operative to determine the position of a marker and sleeve combination, hereinafter simply referred to as a marker 103 in the active area 107, in particular of a tip area 127 of the marker from which ultrasound pulse are emitted (and in some versions, reflected off the page) towards the receiver 111 when the marker is on the page.

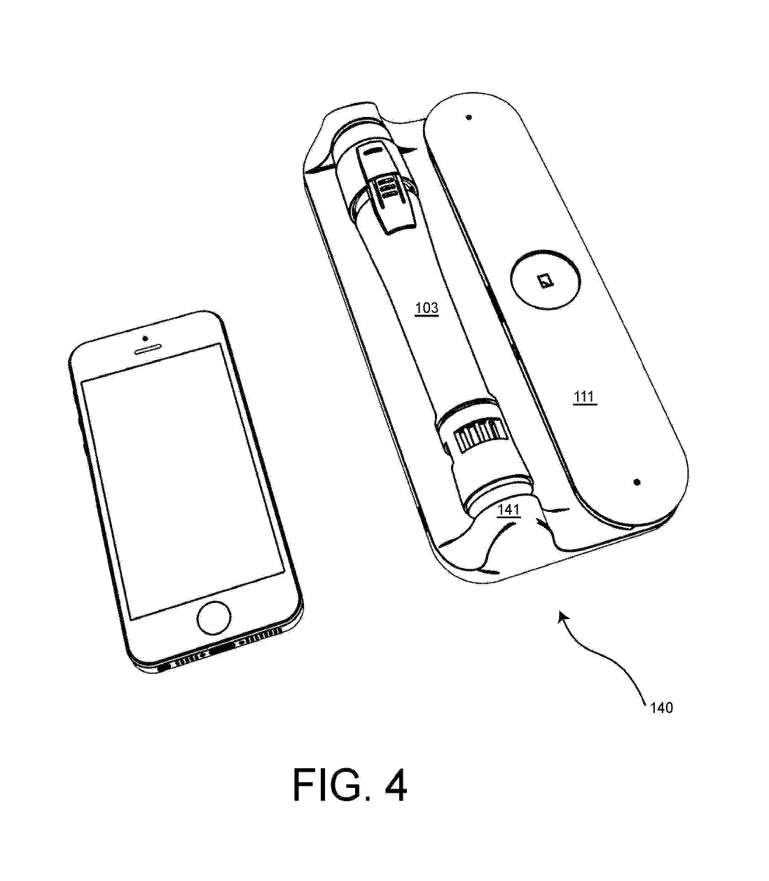

One version of the receiver 111 includes a rechargeable battery 145 and a mechanism for connecting to a charger. Referring momentarily to FIG. 4, a charging station 140 is provided that includes a receptacle 141 into which the receiver 111 may be inserted, and when so inserted, has its battery 145 charged (and also into which the marker 103 may be inserted for storage and for charging of the marker's battery).

In one embodiment of the marker 103, the tip in area 127 is a marking tip of the marker in the sleeve. This embodiment includes a sleeve body, the marker tip 127, and a transmitter of ultrasound pulses 123 in the sleeve body close to the tip 127 arranged to transmit ultrasound pulses detectable by the receiver 111 when the marker is in the active area 107 and pressed into the whiteboard surface 105. In one version, the marker, by way of being inside a marker sleeve, includes electronics to drive the ultrasound transmitter 123 to transmit a set of ultrasonic pulses detectable by the ultrasound sensors 113, 115 when the tip 127 is pressed against the whiteboard surface 105, using, for example, a switch in the marker sleeve, called a pen down switch. The marker 103 shown in FIG. 1 also includes an infrared (IR) transmitter 125 driven by the electronics module 121 and that transmits IR pulses detectable by the IR sensor 117 of the receiver 111 when the tip 127 is pressed against the whiteboard surface 105. The IR pulses are synchronized with the ultrasound pulses.

One embodiment of the marker sleeve 103 further includes one or more buttons each having a switch. When a button is depressed and the marker sleeve is in the active state, so that when pressed in the active area, the transmitters 123,125 transmit energy in a particular form related to which button was depressed. In some embodiments of the invention, the function of the buttons may be programmed, e.g., to be the left or right buttons of a mouse device. Thus, an aspect of some embodiments is that a button of the marker sleeve can provide various optional functions, in the same manner as the different buttons of a mouse or other marker, e.g., for a computer.

In some embodiments, the marker 103, e.g., its sleeve also includes a rechargeable battery 147. In this description, each of the marker 103 and receiver 111 has a receiver battery 145 and marker battery 147, respectively. The charging station 140 (also shown in FIG. 4) is included for charging the batteries. The charging station 140 includes a receptacle 143 designed to hold the marker 103 and recharge the battery 147, and the receiver charger receptacle 141 designed to receive the receiver 111 and charge its battery 145. The couplings between the marker sleeve and its receptacle and between the receiver and receiver charger receptacle 141 are via respective sets of contacts on the respective receptacles in station 140. Alternative embodiments use contactless coupling, e.g., inductive coupling.

The signal transmitted by the transmitters 123,125 of the marker sleeve 103 may be modulated or digitally coded using the electronics module 121 to identify a particular marker function, e.g., that the marker represents a marking device of one color or another, or that the marker represents an eraser, or whether the marker represents a marking device drawing a thin line or a thick line, or whether the button(s), in the marker are functionally the same as the left or right buttons of a mouse, and so forth. One version of the marker sleeve includes a pressure detector, so that the more pressure is applied to the marker tip when the marker is in the sleeve, the thicker the strokes determined and recorded by the receiver 111.

### The Erasure Cap

Referring still to FIG. 1, one embodiment of the system includes an erasure cap 151 that includes an eraser tip 155 that can erase dry marker marks, and that has a pre-determined width. The erasure cap 151 allows for making small corrections to the digitized content from the whiteboard. Since the digital signal is tracked as a single point on the surface, the point can be represented as an area having a physical size, e.g., an area such as a circular area having a diameter. In one embodiment the size, e.g., diameter is pre-defined. In one embodiment, the size, e.g., diameter is settable. In one embodiment, the size, e.g., diameter is 30 mm. Those in the art would understand that the 30 mm is approximate, e.g., between 27 and 33 mm. This is an optimal size for erasing letters between other letters when writing normally on the whiteboard. Of course alternate embodiments might have a different size, and another alternative may have several erasure caps similar to cap 151, but of different sizes.

In one embodiment, the erasure cap 151 is designed to form an airtight seal when on the marker 103 to prevent the marker tip from drying out. One embodiment of the marker 103 comprises an erasure cap detector 129, located for example in the sleeve of the marker, and operative to detect when the erasure cap is on the marker covering the tip. One embodiment of erasure cap 151 includes indicators detectable by the erasure cap detector 129. In one versions, the indicators comprise one or more magnets 153 to generate a magnetic field that can be sensed by the erasure cap detector 129, and the erasure cap detector 129 comprises one or more proximity sensors 128, which in one embodiment, includes one or more Hall-effect sensors and an electronic circuit coupled thereto to detect when the one or more magnets are in close proximity. Such combination of Hall-effect sensors and electronics are commonly available. When the erasure cap 151 is placed on the front of the marker, the one or more Hall-effect sensors are activated by the magnetic field and indicate the electronic circuit to switch to from marking mode to erasing mode.

The erasure cap 151 is mechanically arranged to push the marker inside against the pen down switch as if the user were drawing on the whiteboard. When the erasure cap 151 is in place, the marker transmits a signal to the sensor that is different than that of a marking stroke, and the signal is interpreted in the client software as an eraser stroke.

Additionally, the marker 103 is programmed to cause the system not to make unwanted eraser marks on the board as the user places the cap on the marker. The marker 103 includes a memory that indicates the mode when the marker last transmitted, e.g., that it is currently in marking mode wherein the marker made a stroke without the erasure cap 151 on. When the erasure cap 151 is applied, the magnet is sensed by the erasure cap detector, and the mode is switched to erase mode, so that the data pulse that is normally emitted when the cap is applied is now muted. When the erasure cap 151 is next used on the board surface, it works normally (unmuted) to transmit the erasure cap 151 signal to the sensor.

While one embodiment uses a magnet and switch combination, there are several alternative methods of signalling that the erasure cap 151 is on. Three examples of such alternatives include:
a light sensor on the sleeve body that detects the presence of the cap when it covers the light sensor in a different way compared to the normal cap;
an IR sensor on the marker sleeve body that detects the IR signal via a light path from the IR transmitter to the IR sensor. The light path is broken by an arm on the erasure cap 151; and
a simple sprint loaded pin switch in the sleeve body positioned so that the switch is depressed when the erasure cap 151 is placed on the marker.

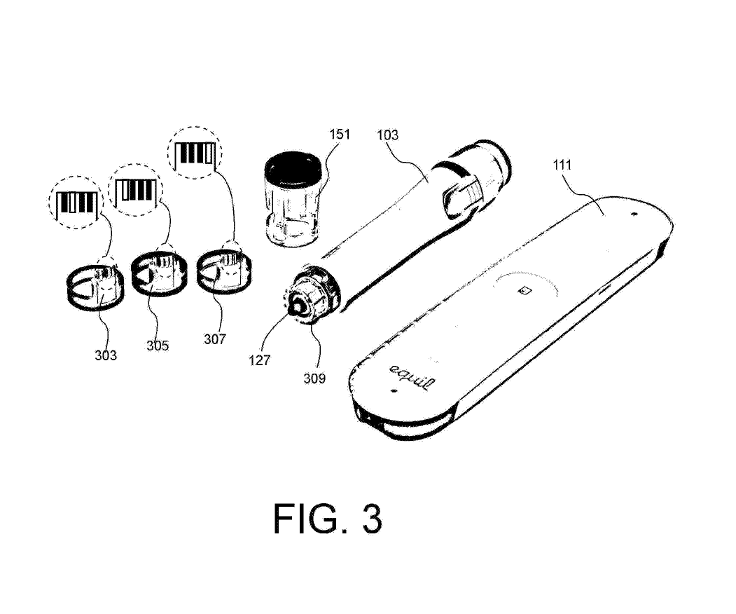

FIG. 3 shows a simplified perspective view of the system that includes the receiver 111, the maker 103 comprising a sleeve with a marker tip therein, the erasure cap 151, and four rings 303, 305, 307, and 309, each to indicate a different color. In one embodiment, the sleeve body 103 can accommodate any one of several different rings to indicate the color of the marker covered by the sleeve. Each ring is encoded, e.g., by a one or more metal jumpers on a corresponding plurality of pins. In rings 303, 305, and 307 (the ring 309 is on the marker's sleeve body), there are four possible jumper locations, and in each, a different set of three is present. Four possible jumper positions on the ring allow for up to 16 different types of markers, e.g., different colors, different widths, and so forth. The invention is not limited to any number of jumper positions. In general, N pins would allow for 2^{N} different marker types. Alternate methods of indicating color or other marker characteristics also are possible within the scope of the invention.

According to another embodiment of the invention, one of the codes is used for a ring that is the side mount for an erasure cap 151, such that when the erasure cap 151 is mounted rather than, or in addition to one of the alternate rings, the electronics in the marker, e.g., the marker sleeve recognizes that an erasure cap 151 is mounted, and so sends out a code with the IR transmission that is recognized as indicative of a n erase.

Yet another alternate embodiment allows for erasers of different size and/or different shape. In such an embodiment, there are a plurality of alternate erasure caps with using different types of elements or methods of indicating, e.g., a plurality of switches and grooves, or a plurality of arms able to cover one or more holes on the marker sleeve body for one or more light sensors, the number of light sensors not necessarily the same as the number of covering arms.

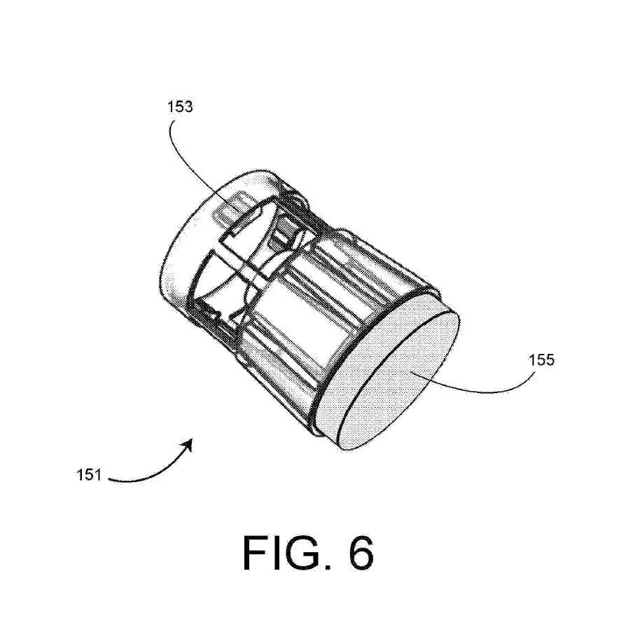

FIG. 6 shows a larger perspective view of an erasure cap 151 than shown in FIGS. 1 and 3, according to an embodiment of the invention.

One version of the marker sleeve 103 has a low power state that draws a relatively small, e.g., minute amount of power, as is common ins so-called “sleep-mode”. Invoking any of the buttons moves the state to an active state and further provides an indication of which button was invoked.

When operational, the location determining system 100 is able to determine the position of the marker sleeve 103 in the active area 107, and thus capture the marker strokes written on the surface 105.

FIG. 2 shows a more detailed, but still simplified block diagram of the system 100 that includes an embodiment of the invention. System 100 includes the marker sleeve 103, the receiver 111 and the host device 150. The system 100 includes an embodiment of the invention and further includes a communication link between the receiver 111 and the host device 150. The ultrasound sensors 113,115 and IR sensor 145 are coupled to a processing engine 131 that includes a processor 203 that in one embodiment is a DSP device, although in alternative devices, this could be a field programmable gate array or a custom integrated circuit. The processor 203 includes or is coupled to a memory 205 for software, e.g., firmware, coupled to processing elements of the processor 203, e.g., via a bus subsystem. Note that while the various processing elements, e.g., multiply-add units, general purpose logic units, and so forth, are shown as a single processor 203 in FIG. 2, those in the art will understand that this does not imply that there is only a single processing element in processing engine 131.

The receiver 111 includes one or more input/output (I/O) interfaces, e.g., one or more of a USB interface, a Bluetooth wireless interface, and a Wi-Fi wireless interface. Other I/O interfaces of course may be included in different embodiments. The I/O interface(s) are shown as a single block 213 in FIG. 2.

In one embodiment, aspects of the present invention include methods that are implemented by sets of instructions in the memory 205, e.g., firmware instructions. Furthermore, while embodiments of the invention use a DSP device, it would be clear to those in the art that any processor with sufficient processing power, e.g., a microprocessor or microcontroller, may be substituted for the DSP device, or alternately, that one or more programmable logic devices, or even hardwired logic may be used, e.g., as an application specific integrated circuits (ASIC) or custom chip.

When an IR signal is detected via the IR sensor 117, a switch connects the output of the ultrasound sensors 113,115 such that by the time the ultrasound signals arrive from the marker sleeve 103, the received ultrasound pulses are input via respective serial ports to the processing engine 131.

A timing generator 215 sends time information to the engine 131. The received ultrasonic pulses together with time information and any information on the state of any buttons on the marker sleeve 103 are sent to the processing engine 131 to determine the times of arrival of the ultrasound pulses relative to the times of arrival of the IR signal. The relative times of arrival together with information on the state of any buttons on the marker sleeve 103 are further processed by processing engine 131.

The firmware memory 205 coupled to the processor 203, which, if a DSP device, may include built-in DSP firmware memory (as all or part of firmware memory 105), and more memory, e.g., additional static RAM, such RAM being all or part of a memory 211.

In one embodiment the firmware memory stores instructions 206 that when carried out by processor 203 to determine the locations of the marker sleeve 103, timing information, and one or more other indications, including any new page indications or indicators. The pulses transmitted by the IR transmitter in the marker sleeve 103 are assumed to travel much faster than the ultrasound pulses, e.g., “instantaneously.” The IR pulses received by the IR receiver 117 and the ultrasound pulses received by the ultrasound sensors 113,115 are recorded in the location determining system 111. In one embodiment, the operation of the location determining of receiver 111 includes determining the times of arrival of the pulses. The location determining system 111 calculates positions of the marker's tip based on the arrival times at the two ultrasonic detector positions. The time reference is generated by the IR sensor. In one embodiment, the calculations rely on accurate recording of waveforms of the received pulses.

The locations, timing information, and other indicators in one embodiment are stored as 251 in the memory 211. One version of the receiver and marker sleeve combination is usable stand-alone without being connected to the host device 150. The receiver and marker sleeve combination is also usable while connected to a host device 150, in which case the locations (as coordinates), timing information, and indicators are transmitted to the host device 150 in real time.

In the stand-alone use case, at some stage, communication is established with the host device 150, and the locations (as coordinates), timing information, and indicators 251 from memory are transmitted to the host device 150.

The host device 150 is also shown in FIG. 1 and in more detail, in FIG. 2, and includes standard components such as a processor 221, memory 223, a USB interface 227, a display 225, one or more wireless interfaces 231, a touch screen 233, a (virtual or physical) keyboard, a battery, and so forth. Aspects of the present invention are implemented, in one embodiment, as instructions 229 in the host device 150, shown in FIG. 2 as in memory 223. The memory 223 also includes such instructions for such functionality as character recognition, etc., and of course, the usual functions of the device 150, e.g., as a phone etc.

The receiver 111 also includes a new page button 119 to provide the user with the ability to indicate when the whiteboard surface 105 will represent a new page.

In one embodiment, the receiver sends the host device location information in the form of A, B un-normalized coordinates, and signals about the type of marker, e.g., color, line thickness, and so forth. Calibration may be carried out using the marker and receiver.

The processing system of location capture system 111 further accepts input indicative of the erasure cap being present on the sleeve. One embodiment also includes detection of coding of colors. In one embodiment, the information sent to the host device is in the form of A,B un-normalized coordinates, and signals about the type of marker, e.g., color, whether eraser or marker, and so forth. In one embodiment, the system is pre-calibrated to cover an area larger than typical whiteboards. In another, a selector determines one of a set of standard sizes and whether the board is in landscape or in portrait orientation. The of A,B un-normalized coordinates are automatically normalized to x,w coordinates in the active area 107.

Calibration may be separately carried out, for example, in the host device to convert the un-normalized A,B coordinates to x,y coordinates in the active area, e.g. to strokes in the active area.

Timing information also is determined. In addition, events such as those that signal marker up and marker down are sent, and erasure cap on. Such events are provided in as (marker-up,timestamp) where the marker-up is the marker-up event and the timestamp is an indication of the time that the event occurred. A,B coordinates are provided in the form of ((A,B), markertype, any error), where the markertype indicates the color, whether an eraser, width, etc. Furthermore, an eraser is regarded as a special erasing marker that erases an area around its coordinate, such that erasure regions also are transmitted. Also events such as one or more buttons on the sleeve being pressed are sent. Thus, the host device, after calibration, accepts a marker down event and a marker up event with a stream of coordinates in between that represents a contiguous line.

In some versions, the system 100 uses a firmware program 206 installed in the receiver 111 to determine and to store the marker strokes that the device captures and to implement the actions of the programmable buttons.

FIG. 4 shows a receiver, a marker sleeve, and a charging bracket with marker-stroke determining capability, into which elements described herein may be included such that the combination operates as an embodiment of the invention.

### Accelerometer

The receiver may include one or more physical sensors that provide indications of a page flip. The sensors are used to detect relative motion between the receiver 111 and the surface 105, or motion in the combination of the receiver 111 and the surface 105.

Some embodiments include an accelerometer 231, or other similar sensor of change of motion. Accelerometers are inexpensive and reliable, because of their use in laptops to detect the laptop being dropped (to part a hard disk therein), and more so because of their use in smart phone and tablet devices, of which more than a billion have been made.

The receiver 111 in one embodiment is configured, via firmware, to monitor the accelerometer 231 output. If the accelerometer output was nearly still for some amount of time, and has high acceleration (above a threshold that depends on the particular accelerometer), there is high likelihood that the user has picked up the receiver 111 in order to move it. In one improved, estimation is made to ascertain whether or not the receiver 111 the angle of the receiver relative to horizontal or vertical positioning.

### Dual-Side Capture

One aspect of the inventive receiver, in the case of horizontal receiver placement, can detect ultrasound from an active region above the receiver and also can detect ultrasonic pulses from a second active region below the receiver. This arrangement allows a single receiver to detect a larger area.

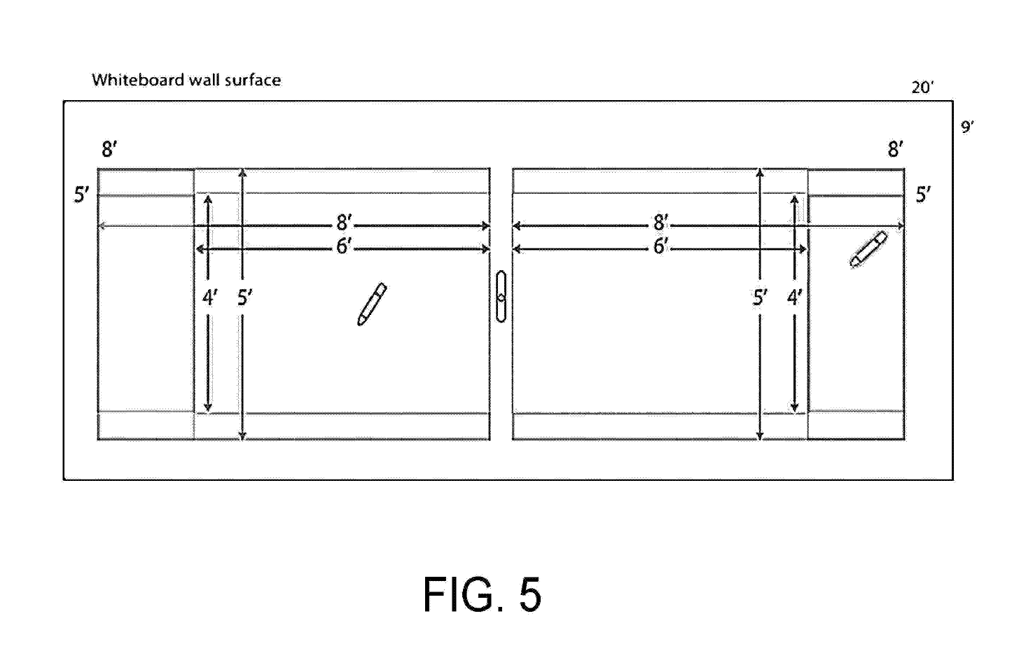

FIG. 5 shows a vertical receiver arrangement with two whiteboards, one on the left and one on the right of the receiver. The receiver has one pair of acoustic sensors, e.g., microphones (or MEMS receivers) and two of IR receivers. A circuit measures the IR intensity of each IR receiver and reports to the processor which side the signal is coming from. This is tracked and notes are recorded into two separate pages in the user software. The user may jump back and forth from the left side to the right side, randomly drawing notes on both sides, using one pen at a time.

This allows the user to record notes on an effective area of 16 feet in width and 5 feet in height.

### Auto Calibration

In one embodiment, the smart marker system does not require the user to perform a calibration process. This improves usability, allowing the user to focus on the content they are creating with very little start up time.

The receiver contains an accelerometer which measures the angle of the receiver when it is placed on the whiteboard surface. Using this angle measurement combined with the IR sensor circuit to know where the signal is coming from, a virtual rectangle is projected on the board surface which defines the virtual boundary of the capture area. The receiver will emit an audible and visual alert if the user attempts to write outside of this virtual boundary.

With auto calibration, the content created will always be level (as it was drawn) and right-side up.

### Recording to Memory

One aspect of a marker system embodiment is recording flexibility by using internal memory in the receiver. Even when the user is has not connected the sensor to a computing device such as a smartphone or laptop PC, everything they writes/draws on the board is stored in memory and can be imported later to their device.

Through a combination of hardware and software, many usability problems are solved by this. For example, in the case a smart-phone is used with an application program (an app) for capture, if the user decided to navigate away from the app while using the whiteboard, the strokes will instead be recorded to memory and merged back to the app when the connection is restored. Without this memory and memory management function, the content would be lost. In one embodiment, a user may record up to 10,000 average density pages of notes.

### New Page Button

The receiver 111, and/or in some embodiments, the transmitting marker sleeve 103 contains the new-page button. Pressing it once, momentarily, at any point in time creates a new page in memory, and the previous page is saved. The new page is blank, allowing you to erase what is on the board.

In one version, the same button changes to a duplicate page button when pressed and held for 2 seconds. The duplicate page feature functions like a snapshot. It makes a copy of whatever you see on the board. This has use advantages over new-page depending on the usage scenario. It can work much like a “Build”” in presentation software, such as “Microsoft PowerPoint”®, or allows you to easily make variations of a drawing—maintaining aspects of the drawing that are left on the board from page to page.

### Charging/Working Cradle

Referring to FIG. 4, in one embodiment, the charging station 140 serves multiple purposes.

Charging station 140 functions as the primary charger for the sensor and marker sleeve. It is powered by a USB cable that requires 5 v at 500 mah or higher. The sensor and pen can be fully charged in 3 hours.

Charging station 140 functions as the carry case for the sensor and sleeve.

Charging station 140 also functions as an on-board charging holder. This allows the user to place the charger on the board surface and continue to use the sensor for an unlimited amount of time.

Charging station 140 also provides a convenient place to store the marker pen when you are done writing. If the user would like to take the sensor and receiver on a business trip, they simply grab them and go. The components remain charged and ready until you choose to use them in a portable way.

While the description above is for a device/system that includes an interactive marker-stroke capture system that uses active marker (with its sleeve), the inventive method and system can easily be applied to interactive marker capture systems as well as interactive tablets with styluses, touch based tablets and other non-keyboard character based methods of input. Additional data such as voice recording can be captured and synchronized to the marker data stream.

One embodiment includes handwriting recognition. There are many methods of recognizing handwriting known in the art, and such details are left out in the interest of brevity.

### General

Unless specifically stated otherwise, as apparent from the following discussions, it is appreciated that throughout the specification discussions utilizing terms such as “processing,” “computing,” “calculating,” “determining” or the like, refer to the action and/or processes of a host device or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory.

The methodologies described herein are, in one embodiment, performable by one or more processors that accept machine-readable instructions, e.g., as firmware or as software, that when executed by one or more of the processors carry out at least one of the methods described herein. In such embodiments, any processor capable of executing a set of instructions (sequential or otherwise) that specify actions to be taken may be included. Thus, one example is a programmable DSP device. Another is the CPU of a microprocessor or other computer-device, or the processing “core” part of a larger ASIC. A processing system may include a memory subsystem including main RAM and/or a static RAM, and/or ROM. A bus subsystem may be included for communicating between the components. The processing system further may be a distributed processing system with processors coupled wirelessly or otherwise, e.g., by a network. If the processing system requires a display, such a display may be included. The processing system in some configurations may include a sound input device, a sound output device, and a network interface device. The memory subsystem thus includes a machine-readable non-transitory medium that is coded with, i.e., has stored therein a set of instructions to cause performing, when executed by one or more processors, one of more of the methods described herein. Note that when the method includes several elements, e.g., several steps, no ordering of such elements is implied, unless specifically stated. The instructions may reside in the hard disk, or may also reside, completely or at least partially, within the RAM and/or other elements within the processor during execution thereof by the system. Thus, the memory and the processor also constitute the non-transitory machine-readable medium with the instructions.

Furthermore, a non-transitory machine-readable medium may form a software product. For example, it may be that the instructions to carry out some of the methods, and thus form all or some elements of the inventive system or apparatus, may be stored as firmware. A software product may be available that contains the firmware, and that may be used to “flash” the firmware.

Note that while some diagram(s) only show(s) a single processor and a single memory that stores the machine-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a non-transitory machine-readable medium coded with, i.e., having stored therein a set of instructions for execution on one or more processors, e.g., one or more processors that are part of the receiver forming a marker stroke capture system.

Note that, as is understood in the art, a machine with application-specific firmware for carrying out one or more aspects of the invention becomes a special purpose machine that is modified by the firmware to carry out one or more aspects of the invention. This is different than a general purpose processing system using software, as the machine is especially configured to carry out the one or more aspects. Furthermore, as would be known to one skilled in the art, if the number the units to be produced justifies the cost, any set of instructions in combination with elements such as the processor may be readily converted into a special purpose ASIC or custom integrated circuit. Methodologies and software have existed for years that accept the set of instructions and particulars of, for example, the processing engine 131, and automatically or mostly automatically great a design of special-purpose hardware, e.g., generate instructions to modify a gate array or similar programmable logic, or that generate an integrated circuit to carry out the functionality previously carried out by the set of instructions. Thus, as will be appreciated by those skilled in the art, embodiments of the present invention may be embodied as a method, an apparatus such as a special purpose apparatus, an apparatus such as a data DSP device plus firmware, or a non-transitory machine-readable medium. The machine-readable carrier medium carries host device readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form a computer program product on a non-transitory machine-readable storage medium encoded with machine-executable instructions.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Any discussion of prior art in this specification should in no way be considered an admission that such prior art is widely known, is publicly known, or forms part of the general knowledge in the field.

In the claims below and the description herein, any one of the terms comprising, comprised of or which comprises is term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Note that the claims attached to this description form part of the description, so are incorporated by reference into the description, each claim forming a different set of one or more embodiments. Therefore, in those jurisdiction that do not permit incorporation of material by reference, a copy of each of the claims may be pasted into the specification at some later date as a description of a set of embodiments, and does not form new matter.

1. An apparatus configured to capture marker strokes made by a marker (103), including capturing erasures when an erasure cap (151) is attached to the marker (103), the apparatus comprising:
a receiver (111) configured to be placed on or close to an edge of a surface (105), the receiver (111) including at least two acoustic sensors (113,115) located at pre-defined locations relative to each other and arranged to sense acoustic signals transmitted from a marker in an active area of the surface adjacent to the location of the sensors (113, 115), the marker (103) including at least one acoustic-energy-transmitter (123) to transmit acoustic signals detectable by the acoustic sensors (113, 115),
wherein the receiver is arranged to determine locations and time information of the marker in an active area (107) on the surface (105) adjacent to the acoustic sensors (113, 115);
wherein the receiver (111) includes an interface (213) to couple the receiver with a host device (150), the host device including a host processor (221) and a memory (223),
wherein the receiver (111) is operative, when coupled to the host device (150), to send determined locations and time information to the host device,
wherein when the marker (103) has a removable erasure cap (151) thereon, the receiver alone, or in combination with the host device, is operative to accept an indication that the erasure cap is on the marker (103).

2. The apparatus as recited in claim 1, wherein the receiver is further operative to store the determined locations and time information.

3. The apparatus as recited in claim 1, wherein the receiver (103) includes a sensor (117) of electromagnetic energy pulses transmitted from the marker, and the marker comprises an electromagnetic-energy-pulse transmitter (125) that is operative to transmit electromagnetic energy pulses detectable by the sensor (117) of electromagnetic energy pulses.

4. The apparatus as recited in claim 1, wherein the receiver (111) comprises a processing engine (131) that includes a processor (203) and a memory (205, 211) having stored therein instructions (206) that when executed cause the determining and the storing of the locations and time information (251), and when the receiver (111) is coupled to the host device (150), cause the sending of the determined locations and time information to the host device.

5. The apparatus as recited in claim 1, further comprising:
responsive to receiving the indication that the removable erasure cap (151) is on the marker (103), the determined locations forming erasure locations, such that the marker-and-erasure-cap combination causing erasure of previously made strokes at the determined locations.

6. The apparatus as recited in claim 5, wherein the marker transmits a code to indicate that said determined locations are said erasure locations.

7. The apparatus as recited in claim 5, wherein each determined location that forms one of the erasure locations forms a corresponding erasure area around said determined location, the corresponding erasure area having a physical size.

8. The apparatus as recited in claim 7, wherein the corresponding erasure area is a circular area having a diameter.

9-12. (canceled)

13. The apparatus as recited in claim 8, wherein the removable cap is one of a plurality of removable caps, each configured to respective corresponding areas each having a different size and/or a different shape.

14. The apparatus as recited in claim 1, wherein the marker (103) includes a marker tip that can make physical marks on the surface, and the erasure cap (151) comprises an eraser tip (155) that can erase marks made by the marker tip.

15. The apparatus as recited in claim 1, wherein the marker (103) includes a marker tip that can make physical marks on the surface and the erasure cap (151) is designed to form an airtight seal when on the marker (103) to prevent the marker tip from drying out.

16. The apparatus as recited in claim 1, wherein the marker (103) comprises an erasure cap detector (129) operative to detect when the erasure cap is on the marker, and when the erasure cap detector (129) senses that the erasure cap is on the marker sleeve, and the erasure-cap-and-marker combination is in the active area (107), interpreting the determined locations and time information as erasure information.

17. The apparatus as recited in claim 16, wherein the erasure cap (151) includes one or more indicators detectable by the erasure cap detector (129).

18. The apparatus as recited in claim 17, wherein the indicators comprise one or more magnets (153) to generate a magnetic field that can be sensed by the erasure cap detector (129), and the erasure cap detector (129) comprises one or more proximity sensors (128) operative to detect the magnetic field.

19-21. (canceled)

22. The apparatus as recited in claim 1, wherein the erasure cap (151) is mechanically arranged to activate the transmitting of the ultrasound and IR pulses when the eraser is on the surface.

23. The apparatus as recited in claim 1, wherein the marker (103) when activated operates in a marking mode or in an erasure mode, and wherein the marker includes a memory that indicates whether the marker last transmitted in marking mode or erasure mode, and wherein in the case the last transmitted mode is marking mode, and the erasure cap is placed on the marker, transmitting from the marker is muted until the erasure cap is places on the surface, such that false erasures are not made.

24. The apparatus as recited in claim 1, further comprising a mechanism to indicate a new page, such that erasures are only made on the current page.

25. (canceled)

26. The apparatus as recited in claim 24, wherein the receiver alone, or in combination with the host device, is operative to accept or determine a plurality of indicators of page-flip, and to combine the plurality of indicators to automatically determine a page flip event.

27. The apparatus as recited in claim 26, wherein the receiver includes one or more physical sensors to provide a respective indicator of page-flip, including at least one member of the set consisting of:
an accelerometer;
a mechanical press-switch requiring very light force to press, and located at the bottom of the receiver housing;
a proximity sensor; and
a set of one or two light sensors.

28. The apparatus as recited in claim 24, wherein the detection of a page flip event causes complete erasure of the previous page.

29-82. (canceled)
